(19) United States
(12) Patent Application Publication
(10) Pub. No.: US 2014/0311979 A1
(43) Pub. Date: Oct. 23, 2014

(54) Device and Method for Producing Sterile Water by Means of a Cross-Flow Liquid Sterile Filter

(71) Applicant: Alexander Schluttig, Lauta (DE)

(72) Inventor: Alexander Schluttig, Lauta (DE)

(21) Appl. No.: 14/358,013

(22) PCT Filed: Nov. 17, 2011
(86) PCT No.: PCT/EP2011/005789

§ 371 Date: May 13, 2014

(51) Int. Cl. C02F 1/44

(52) U.S. Cl. CPC C02F 1/44
USPC 210/650; 210/321.6

(57) ABSTRACT

The aim of the invention is to provide a device and a method for producing sterile water by means of a cross-flow liquid sterile filter without the closure of the water line during the filtration process, said closure being bacteria-tight according to the prior art of point-of-use potable-water sterile filtration, and without the negative consequences associated with said closure. Said aim is achieved according to the invention by the simultaneous, continuous discharge of the germ-containing retentate from the cross-flow liquid sterile filter during the filtration and the disinfection thereof in a disinfecting apparatus. The result of the interaction of all components according to the invention is therefore a device and a method by means of which sterile and endotoxin-poor water can be produced without bacteriological closure of the water line, without interruption of the filtration at short intervals, and with maximum hygienic safety and which thus no longer have all the stated disadvantages of the POU sterile filters described according to the prior art and used in practice.

The invention relates to a device and a method for producing sterile water by means of a cross-flow liquid sterile filter, without bacteria-proof closure of the water line during the filtration process.

The closest prior art disclosing the use of hollow-fiber membrane filters for point-of-use sterile filtration of drinking water is DE 199 18 221 C1. The teaching described in the latter provides for a cross-flow liquid sterile filter, which permits alternate withdrawal of filtered and unfiltered water by the presence of separate outlet openings. An earlier teaching U.S. Pat. No. 4,980,056 A describes a filter in the form of a hollow-fiber membrane bundle with an outlet opening for sterile water and an outlet opening for germ-containing retentate. However, the withdrawal of unfiltered drinking water through one of the two outlet openings is not provided.

The main disadvantage of both teachings is that the germ-containing retentate is not transported away during the filtration.

Point-of-use (POU) sterile filtration of drinking water with cross-flow liquid sterile filters has in practice hitherto been carried out exclusively as dead-end filtration. The simultaneous removal of germ-containing retentate from the filter during the filtration without guaranteed disinfection is in fact extremely disadvantageous from the point of view of hygiene and cannot therefore be practiced in clinical high-risk areas. Because of this lack of removal of germ-containing retentate, POU sterile filters for drinking water have extremely short safe-usage times. The technological reasons for this are described below.

In the clinical application of point-of-use (POU) sterile filtration of drinking water by means of cross-flow liquid sterile filters, not only must microorganisms be separated as completely as possible from the germ-containing water to be filtered, it is also important to avoid the release of endotoxins (pyrogens) from filtration coatings on the filter medium, which role has not hitherto been suspected or recognized by clinical users.

Another important disadvantage of any sterile filtration is the method-related bacteria-proof closure of the water line, upstream of the filter, by the bacteria-proof membranes used for the filtration. This bacteria-proof closure leads to the accelerated retrograde microbiological contamination of the water line. However, this fact has not hitherto been taken into consideration in the clinical sector. The accelerated retrograde contamination of the water line leads not only to increased release of endotoxins but also to a high concentration of organic constituents, which in turn shortens the hygienic life of the sterile water filtered according to the prior art. The high concentration of organic constituents in fact promotes recolonization of the sterile-filtered water with microorganisms.

The prior art of POU sterile filtration of drinking water is briefly summarized once again hereinbelow by inclusion of DE 199 18 211.

As is known, sterile filters of the kind used according to the prior art in the industrial and clinical sector for the separation of microorganisms from drinking water as point-of-use (POU) filters work according to two principles:
1. Static pressure filtration: The separation of particles, colloids and microorganisms takes place when the water to be filtered is forced by pressure to flow through a filter medium, for example a membrane, a membrane bundle or a ceramic filter body. In the sterile filtration of water, a sterile filtrate stream is thus obtained, and the separated microorganisms remain on the membrane and accumulate there (U.S. Pat. No. 4,989,056). The filtration can then proceed until the filter medium is saturated with separated particles and microorganisms.
2. Dynamic cross-flow filtration: The particular aspect of the use according to the prior art is that, because of hygiene problems in the disposal of the germ-containing retentate, the point-of-use cross-flow filtration in the practice of sterilization of drinking water is performed as dead-end filtration, with the retentate outlet closed during the filtration. This also applies to the practical implementation of the filter described in DE 199 18 221 with two separate outlets.

Both systems, which represent the prior art in point-of-use (POU) filtration of drinking water, have the following disadvantages in terms of hygiene and limited functionality:

1. The separated microorganisms are retained and concentrated, depending on the requirements, on a membrane (static filtration) or in a space between membranes (dynamic dead-end filtration). This in turn favors three processes that are disadvantageous in terms of the intended filtration:
a) The release of endotoxins or pyrogens (microbial cell constituents that cause inflammation) by the method-induced death and subsequent decomposition (lysis) of the microorganisms. The accumulation and concentration of separated microorganisms in the filtration space of the filter leads, on account of the inadequate conditions (oxygen) for these microorganisms, to their death and decomposition (lysis), and therefore to the release of cell wall constituents called endotoxins or pyrogens. Because of their small size, these can pass through the filter if the pore size of the latter lies in the range of the membranes used for sterile filtration according to the prior art, namely 0.1-0.2 micrometer. In terms of economy and availability, it is usually of advantage if the filters can be used without interruption over long periods of time. However, the longer the service life of these filters, the higher necessarily the concentration of organic substances and pyrogens in the sterile filtrate. Moreover, if the microorganisms separated by the cross-flow filtration are expelled at a time following the filtration or between the filtration cycles (DE 199 18 221) for the purpose of regenerating the filter for re-use, this does not prevent the described death and decomposition of these microorganisms and, consequently, the release of pyrogens. In clinical practice, particularly in immunosuppressed patients, pyrogens lead to sometimes life-threatening inflammatory phenomena and therefore make it problematic to use this filtration method, which is absolutely essential for the required generation of sterile drinking water.
b) Sterile filters according to the prior art represent a hydraulically open, bacteria-proof closure of the drinking water conduit system. The resulting retention of microorganisms leads to these accumulating in the conduit system (sanitary fitting, drinking water conduit) and thus to an accelerated retrograde colonization with the microorganisms separated by the filtration. The concentration of microorganisms in the conduit system is overall constantly increased by this retrograde colonization as a result of extremely high concentrations of filtered microorganisms upstream of the filtration barrier and, consequently, promotes and accelerates the feared formation of a biological film. The consequence is that a conduit system initially contaminated with a small number of microbes is more highly contaminated after use of the filter. By contrast, without the filtration, and with a free outlet, microorganisms are constantly expelled from the conduit system, which delays the colonization of the conduit system.
c) Some of the separated microorganisms, namely those that can increase in number even under the conditions prevailing in the filtration medium, for example at relatively low oxygen partial pressures, penetrate into the filtration membrane, increase in number there and destroy the integrity thereof by the formation of channels. The integrity of a filter describes the retention capacity of a filter matrix and is based on preserving the spatial structures within this matrix. The destruction of the integrity of filtration membranes leads to the premature loss of functionality and therefore to reduced usage times. Particularly in the clinical sector, processes of this kind result in a difficult-to-calculate risk, which can only be reduced by short usage times of the filter, which in turn leads to more expenditure in terms of logistics and money.
d) The sterile-filtered water from the water line contains all those microbial decomposition products (lysis products) and cell constituents as nutrients for microorganisms downstream of the filtration barrier. However, on account of this increased nutrient content (measurement as TOC or BOD value), the sterile water thus generated is particularly susceptible, after leaving the sterile filter, to microbial recolonization and thus undergoes microbial contamination more quickly than unfiltered water. This circumstance has a particularly negative impact on the open filter outlet (permeate outlet) of the filter housing according to the prior art since, on account of the increased nutrient content, the microbial colonization of the filter outlet by germs from the environment, so-called retrograde contamination, is greatly accelerated.

In practice, therefore, the possible usage time of the sterile filter is not determined, as might initially be assumed by a person skilled in the art, by the saturation of the uptake capacity of the filter membranes, but by the speed of this retrograde contamination on the unprotected permeate outlet. The process of sterile filtration becomes absurd if the sterile-filtered drinking water, after passing through a contaminated permeate outlet, contains more microorganisms than the unsterile, germ-containing mains water before the filtration. This problem is generally known and limits the useful life of POU sterile filters in general. In clinical practice, this considerable disadvantage of retrograde contamination is countered by two methods: 1. By antimicrobial coating of the filter housing and use of e.g. silver-plated filtrate outlets. 2. By reduced usage times of the sterile filter. In particular, the reduced usage times of the used filter constitute an important disadvantage in practice.

The object of the invention is to make available a device and a method which do not have the aforementioned disadvantages of point-of-use sterile filters according to the prior art and which in particular permit reliable provision of sterile water and avoid retrograde contamination.

According to the invention, the object is achieved by a device for producing sterile water, having a water line and a cross-flow liquid sterile filter which is mounted on a water fitting or integrated in a water-fitting housing and which has at least one permeate outlet for (sterile) permeate and at least one retentate outlet for germ-containing retentate, characterized in that the device has an apparatus for disinfecting the germ-containing retentate, and the retentate outlet of the cross-flow liquid sterile filter and the apparatus for disinfecting the germ-containing retentate are connected to each other via a retentate line, through which germ-containing retentate arising in the cross-flow liquid sterile filter is transferred into the apparatus.

Furthermore, the object is achieved by a method for producing sterile water, wherein germ-containing water is cleaned in a device using the following steps:
a) germ-containing water flows from a water line into a cross-flow liquid sterile filter,
b) the microorganisms present in the germ-containing water are held back in the filter and accumulate in a germ-containing retentate,
c) resulting (sterile) permeate leaves the cross-flow liquid sterile filter via the permeate outlet,
   characterized in that
d) the germ-containing retentate is conveyed continuously out of the cross-flow liquid sterile filter via a retentate outlet during the filtration process b),
e) the germ-containing retentate is transferred from the retentate outlet through a retentate line into an apparatus for disinfection, and
f) the pathogens contained in the germ-containing retentate are all killed in the apparatus without interruption of the filtration process b).

The invention thus relates to a device and a method for producing sterile water by means of a cross-flow liquid sterile filter, without bacteria-proof closure of the water line during the filtration process and, therefore, without the negative consequences that this closure has on point-of-use sterile filtration. This is achieved, according to the invention, by the simultaneous, continuous disposal of the germ-containing retentate from the cross-flow liquid sterile filter during the filtration, and by the disinfection thereof in a disinfecting apparatus, preferably a self-disinfecting drain trap of known configuration.

Compared to static filtration methods, the method according to the invention, using cross-flow filtration, has the advantage that the continuous expulsion of the filtered material from the cross-flow filter avoids saturation of the filter matrix with separated particles and microorganisms and thus permits a substantially longer operating time of the filter.

Since, prior to the development of the device according to the invention, there was no possibility of hygienically safe, continuous disposal of the germ-containing retentate during the filtration process, the microorganisms accumulating in the filter during the use thereof had to be removed from time to time with the filter, and the filter had to be inserted again after chemical cleaning and sterilization. Only when tests were carried out on the one hand with commercially available sterile filters according to the prior art and, by comparison, with the device according to the invention was it surprisingly found that organic substances and endotoxins were released to an unexpectedly high degree both from point-of-use static cross-flow sterile filters and also from point-of-use dynamic cross-flow sterile filters, indeed operated statically according to the prior art.

It has been shown in the context of the invention that it is possible, according to the invention, to prevent both the release of microbial endotoxins and also the accelerated retrograde contamination of the water line by means of removal of the germ-containing retentate taking place simultaneously with the cross-flow sterile filtration. The continuous removal of the germ-containing retentate during the filtration is therefore an advantage of the device according to the invention and of the method according to the invention.

According to the invention, the following is achieved by the continuous removal and disinfection of the separated microorganisms:
1. The deposition of filtered microorganisms on the filter membrane or in spaces between the filter membranes (membrane fouling) is avoided by continuous removal of the germ-containing retentate during the filtration process.
2. The bacteria-proof closure of the water line, with the known negative consequence of increased retrograde colonization, is avoided.
3. By avoiding the decomposition of the microorganisms in the cross-flow liquid sterile filter itself, the colonization of the sterile permeate with organic substances is avoided. The accelerated retrograde contamination of the permeate outlet of the cross-flow liquid sterile filter is thereby avoided. The associated hygiene risks are eliminated and, therefore, the possible safe usage time is greatly increased.
4. By preventing the growth of microorganisms into the filtration membranes, and the associated destruction of the integrity of the membranes, the safety of the sterile filtration method greatly increases. The possible usage time of the cross-flow liquid sterile filter is not reduced by safety concerns.

By connecting the retentate outlet of the cross-flow liquid sterile filter to a disinfection apparatus, preferably in the form of a self-disinfecting drain trap, e.g. in the form of a drain trap as described in EP 1 159 493 B1, the germ-containing retentate that arises during the filtration can be continuously disposed of hygienically and safely via a retentate line. It is only through this combination according to the invention that the advantages of dynamic cross-flow filtration can also be made effective for the particular application of point-of-use sterile filtration of germ-containing water.

By the considerable lengthening of the hygienically safe operating times of the point-of-use cross-flow liquid sterile filter by means of the device according to the invention for continuous production of sterile water that is low in pyrogens, the necessary hygiene safety is ensured for the first time over longer periods and without interruption of the filtration and, consequently, the economic feasibility of this filtration is greatly increased. There are therefore no longer any sanitary, technical or economic constraints against universal application of this hygiene measure which is vital for immunosuppressed patients. The invention thus makes an important contribution to improving hospital hygiene, since it is only through the teaching of this invention that the function of the point-of-use cross-flow liquid sterile filter can be fully exploited without any restrictions and negative side effects.

The result of the inventive interaction of all the components is therefore a device and a method by which sterile water that is low in pyrogens can be generated without bacteriological closure of the water line, without interruption of the filtration at short intervals and with maximum hygiene safety, which device and method therefore no longer have any of the stated disadvantages of the POU sterile filters described in the prior art and used in practice.

The construction and function of the device according to the invention for continuous production of sterile water low in pyrogens, without bacteria-proof closure of the water line, are described below.

The device according to the invention has a cross-flow liquid sterile filter which is composed of a filter housing which preferably accommodates a hollow-fiber membrane filter insert that contains hollow-fiber membranes, the latter being arranged in a bundle, for example. Through a system of seals, the sterile permeate is spatially separated from the germ-containing retentate. The cross-flow liquid sterile filter also has a retentate outlet, which is provided with a retentate line. The sterile permeate resulting from the passage of the germ-containing water through the filter insert leaves the cross-flow liquid sterile filter via the permeate outlet. The germ-containing retentate leaves the cross-flow liquid sterile filter via the retentate outlet, which is provided with a retentate line. The retentate line opens into a disinfection apparatus. In the apparatus, the germs contained in the germ-containing retentate are killed by heat, ultraviolet light, ultrasound, or by a combination of these.

The self-disinfecting drain trap is preferably a drain trap as described in WO 2000/053857 A1 and EP 1 159 493 B1. As regards the nature of the drain trap, reference is made to WO 2000/053857 A1. A self-disinfecting drain trap of this kind is placed in the waste-water lines of the device according to the invention and has a drain trap of any desired structure with a confining liquid contained therein as intended and at least one ultrasonic oscillation system of any desired frequency and at least one system for heating the interior of the drain trap. The two systems are controlled such that a cleaning and disinfection of the drain trap and of the liquid located in the drain trap takes place during the use of the drain trap. When using oscillation systems with ultrasound frequency, the germs are already killed at temperatures that lie below the usual temperature needed to kill the microorganisms to be killed, and within a time that is shorter than the time usually needed to kill these microorganisms, and without function-impairing evaporation losses of the confining liquid. Spore-forming germs are also killed, and also other germs that are difficult or impossible to kill at normal pressure and temperatures of up to 100° C., and germs that are resistant to high temperatures. At the same time, the inner surfaces of the drain trap are cleaned hereby, and growth on the wall in the drain trap and in the adjoining pipeline sections is prevented, thus effectively and safely preventing retrograde contamination of the opening of the pipeline and the environment thereof.

In the method according to the invention, germ-containing water from the water line flows through the hollow-fiber membrane filter insert. The microorganisms present in the germ-containing water are held back by the hollow-fiber membranes as the water passes through the latter, and they accumulate in the germ-containing retentate. The sterile permeate resulting from the passage of the germ-containing water through the hollow-fiber membranes leaves the cross-flow liquid sterile filter via the permeate outlet. The germ-containing retentate leaves the cross-flow liquid sterile filter via the retentate outlet, which is provided with a retentate line. The retentate flows from the retentate line into a self-disinfecting drain trap. In the self-disinfecting drain trap, the germs contained in the germ-containing retentate are killed by heat, ultraviolet light, ultrasound, or by a combination of these.

The method according to the invention is preferably carried out in the device according to the invention.

To further increase the hygiene safety of the cross-flow liquid sterile filter, the device according to the invention preferably has a permeate outlet protector for avoiding retrograde microbial contamination at the permeate outlet. This permeate outlet protector serves to avoid direct contact with the filter environment (splashing water, germ-containing aerosols in the surrounding air), such that the danger of contamination of the permeate outlet is completely eliminated. Since the permeate outlet protector is intended to be changed at much shorter intervals than the cross-flow liquid sterile filter itself, preferably on a daily basis, retrograde contamination of the permeate outlet is completely avoided. The permeate outlet protector can be changed each day in a matter of seconds, without difficulty and without aids, by virtue of two retaining beads, which also ensure a sufficiently secure connection between permeate outlet and permeate outlet protector. The permeate outlet protector is preferably composed of a tubular, self-closing elastic polymer body. In one embodiment, the polymer body has a tubular area and a retaining bead at one of the ends. The shape is roughly comparable to the lower attachment piece of an air balloon. The polymer body is opened by the pressure of the sterile permeate generated in the filter interior, and it is closed again by the external air pressure after completion of the discharge of the sterile permeate from the cross-flow liquid sterile filter.

The invention is explained in more detail with reference to the following examples.

### EXAMPLE 1

The device according to the invention can be mounted on a wash basin or sink. A water line is provided with a water fitting for the purpose of withdrawing water. A point-of-use cross-flow liquid sterile filter is mounted at the outlet of the water fitting in order to produce sterile water. The point-of-use cross-flow liquid sterile filter has a retentate outlet which is open during the filtration. During the filtration, the germ-containing retentate passes through a retentate line into a self-disinfecting drain trap, which is installed under a wash basin or sink.

### EXAMPLE 2

The device according to the invention for producing sterile water, as described in Example 1, is provided, at the permeate outlet of the point-of-use cross-flow sterile filter, with a permeate outlet protector for avoiding retrograde microbial contamination of the permeate outlet.

### EXAMPLE 3

In a further embodiment, the device according to the invention is likewise mounted on a wash basin or sink. In this variant, the point-of-use cross-flow sterile filter is accommodated with permeate outlet, retentate outlet and retentate line in a water-fitting housing.

### EXAMPLE 4

In one embodiment, the device according to the invention has a permeate outlet protector. This permeate outlet protector of the device according to the invention is composed of a self-closing polymer body, which is pushed like a hose over the permeate outlet and which is fixed by a first retaining bead on the polymer body and by a second retaining bead on the permeate outlet.

### EXAMPLE 5

In a further embodiment, the device according to the invention can be mounted on a shower unit. A water line is provided with the device according to the invention for the purpose of withdrawing water for showering. The point-of-use cross-flow liquid sterile filter here has a filter housing which is designed such that the sterile permeate emerging through the showerhead-shaped permeate outlet produces a shower jet. The cross-flow liquid sterile filter has a retentate outlet which is open during the filtration. During the filtration, the germ-containing retentate passes through a retentate line into a self-disinfecting drain trap. In the design as a shower attachment, the filter housing is adjoined by a shower grip. The retentate line is connected, for example, to a self-disinfecting drain trap, wherein the self-disinfecting drain trap is mounted at the outlet under the shower tray.

### EXAMPLE 6

A water line is provided on the water fitting with a flexible supply and removal line and a device according to the invention. The flexible supply and removal line contains a water line through which germ-containing water reaches the cross-flow liquid sterile filter, and a retentate line which is connected to the retentate outlet of the cross-flow liquid sterile filter. During the filtration, the germ-containing retentate passes through the retentate line into a self-disinfecting drain trap, which is located under a wash basin or sink. The filter housing is provided with a shower grip. The sterile permeate emerging from the showerhead-like permeate outlet of the cross-flow liquid sterile filter produces a shower jet with which the relevant area of the body is cleaned.

The invention is explained in more detail with reference to the following figures.

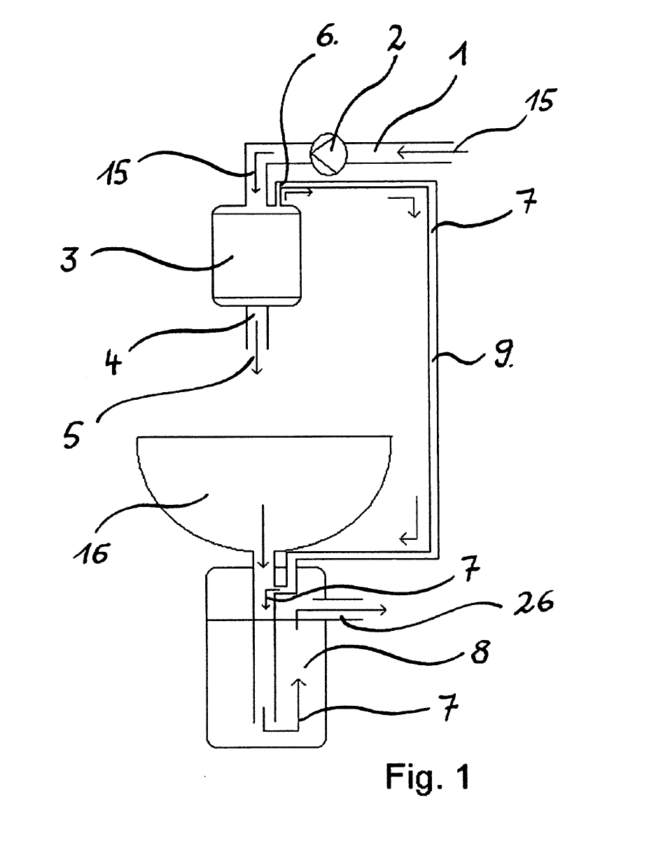

FIG. 1 shows a first embodiment of the device according to the invention. A water line 1 is provided with a water fitting 2 for the purpose of withdrawing water. A point-of-use cross-flow liquid sterile filter 3 is mounted at the outlet of the water fitting 2 in order to produce sterile water. During the operation according to the invention, germ-containing water 15 flows through the water line 1 and the water fitting 2 to the cross-flow liquid filter 3 in the direction of the arrows shown in the figure. The water is freed of microorganisms in the filter 3. The point-of-use cross-flow liquid sterile filter 3 has a retentate outlet 6 which is open during the filtration and via which the retentate 7 is transported away. During the filtration, the germ-containing retentate 7 arising from the filtration passes through a retentate line 9 into a self-disinfecting drain trap 8, which is installed under a wash basin or sink 16. The water flowing out of the wash basin or sink also flows into the drain trap 8. The water is transported away from the drain trap 8 via a waste-water line 26.

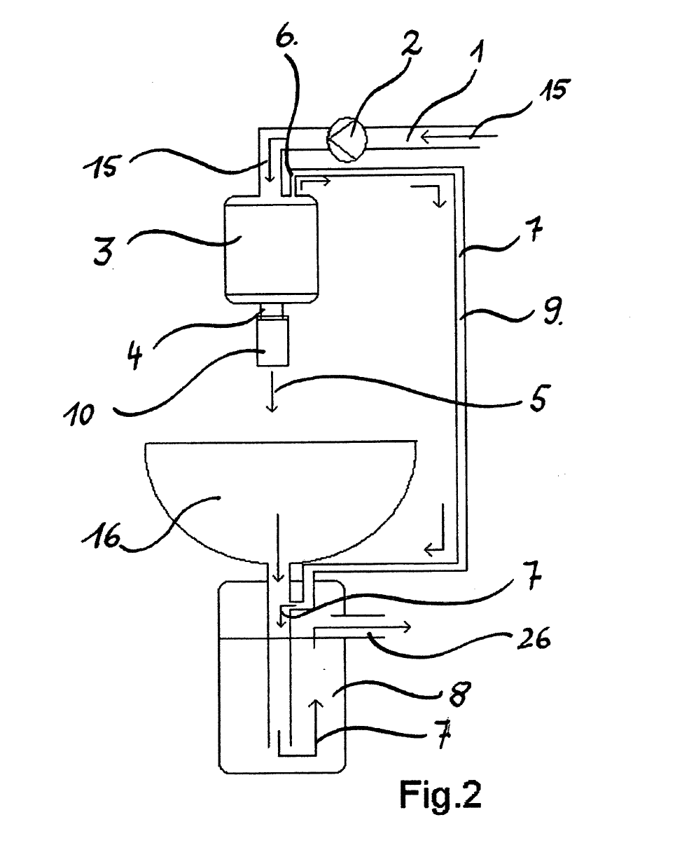

FIG. 2 shows a device according to the invention as in FIG. 1, which device is additionally provided with a permeate outlet protector 10 for avoiding retrograde microbial contamination of the permeate outlet 4. The permeate 5 in this case flows out of the filter 3 through the permeate outlet protector 10.

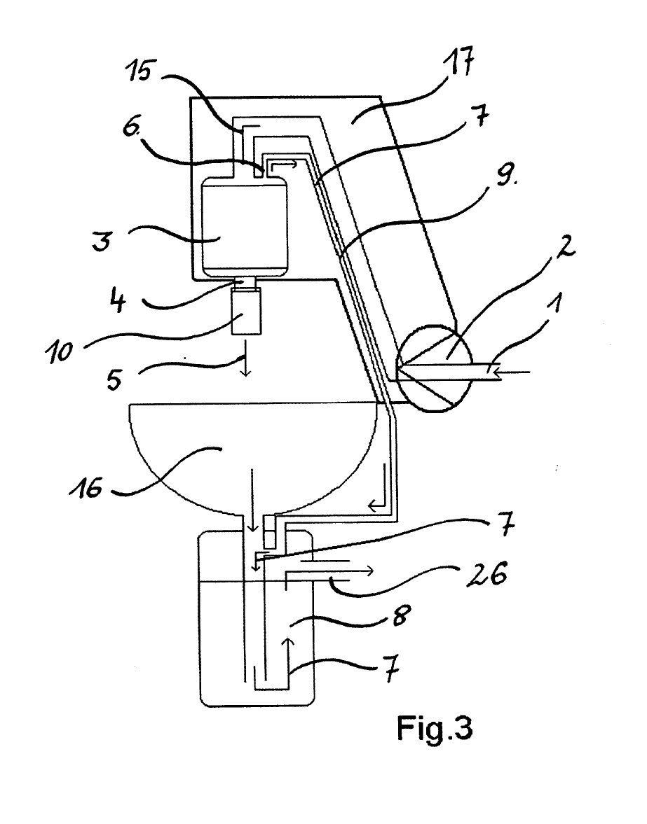

FIG. 3 shows a further embodiment of the device according to the invention. The point-of-use cross-flow sterile filter 3 is accommodated with permeate outlet 4, permeate outlet protector 10, retentate outlet 6 and retentate line 9 in a water-fitting housing 17.

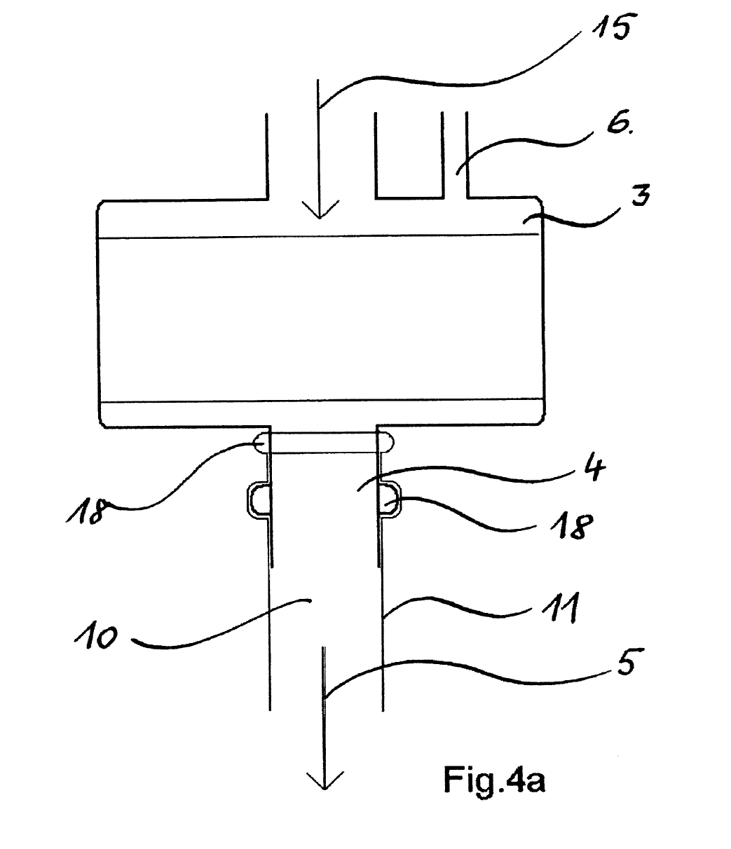

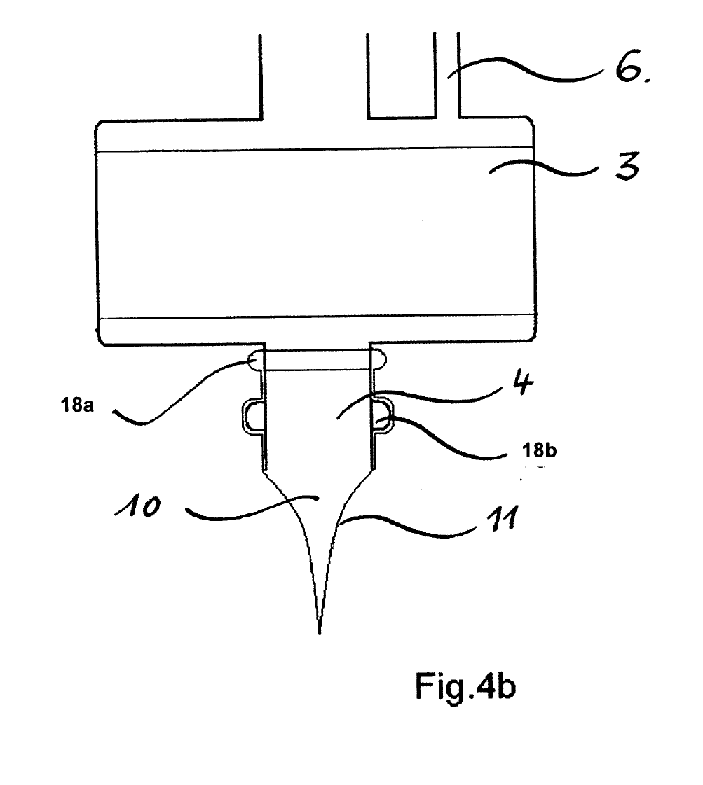

FIGS. 4a and 4b show a permeate outlet protector 10 for avoiding retrograde microbial contamination of the permeate outlet 4 in the open state (FIG. 4a) and the closed state (FIG. 4b). The permeate outlet protector 10 is composed of a self-closing polymer body 11, which is pushed like a hose over the permeate outlet 4 and which is fixed by a first retaining bead 18a on the polymer body 11 and by a second retaining bead 18b on the permeate outlet 4.

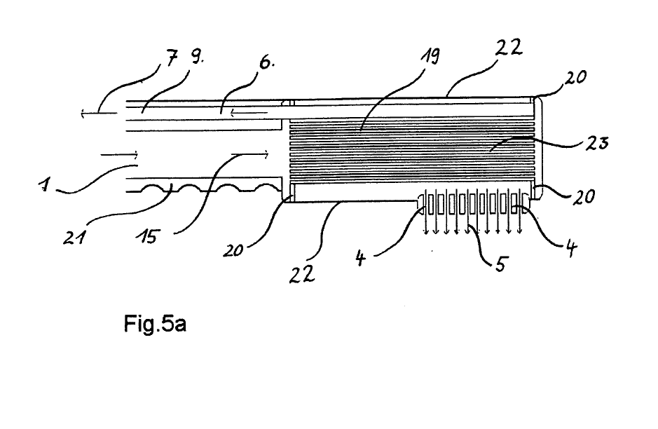

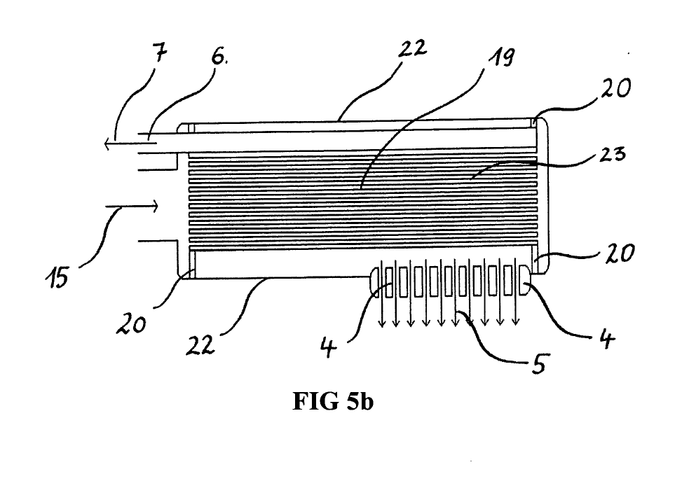

A further embodiment of the device according to the invention is shown in FIGS. 5a and 5b. A water line 1 is provided with a point-of-use cross-flow liquid sterile filter 3 for the purpose of withdrawing water for showering. The filter housing 22 is here designed such that the sterile permeate 5 emerging through the showerhead-shaped permeate outlet 4 produces a shower jet. The cross-flow liquid sterile filter 3 has a retentate outlet 6 which is open during the filtration. During the filtration, the germ-containing retentate 7 passes through a retentate line 9 into a self-disinfecting drain trap (not shown here). In the case of a shower attachment, the filter housing is adjoined by a shower grip 21 (FIG. 5a).

The cross-flow liquid sterile filter 3 is composed of a filter housing 22 which accommodates a hollow-fiber membrane filter insert 19 that contains hollow-fiber membranes 23. Through a system of seals 20, the sterile permeate 5 is spatially separated from the germ-containing retentate 7. In the process, germ-containing water 15 from the water line 1 flows through the hollow-fiber membrane filter insert 19. The sterile permeate 5 arising from the passage of the germ-containing water 15 through the hollow-fiber membranes 23 leaves the cross-flow liquid sterile filter 3 via the permeate outlet 4. The germ-containing retentate 7 leaves the cross-flow liquid sterile filter 3 via the retentate outlet 6, which is provided with a retentate line 9. The retentate line 9 opens into a self-disinfecting drain trap (not shown here).

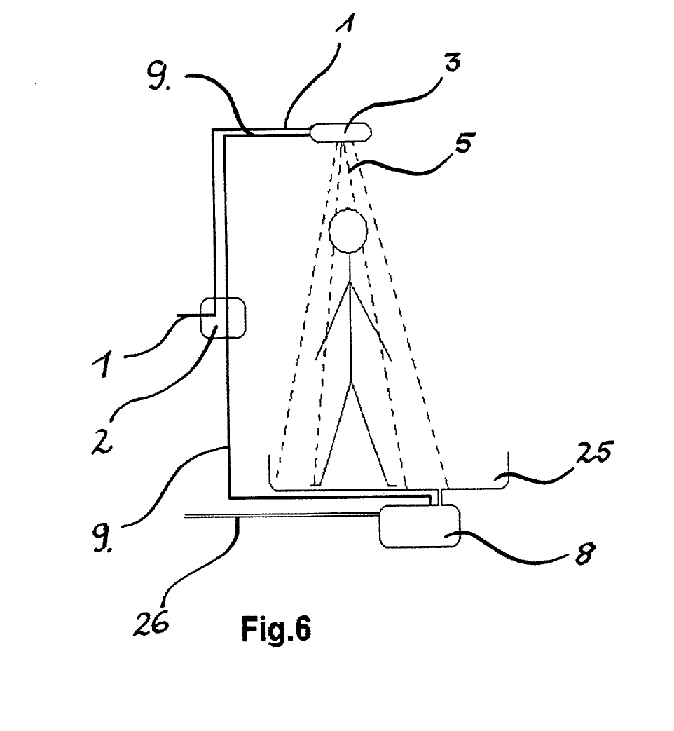

FIG. 6 shows the device according to the invention in combination with a shower tray 25. A shower device shown in FIG. 5a is connected to a self-disinfecting drain trap 8 via a retentate line 9. The self-disinfecting drain trap 8 is mounted at the outlet under the shower tray 25. Both the water from the shower tray 25 and also the retentate 7 flow through the apparatus 8 into the waste-water line 26.

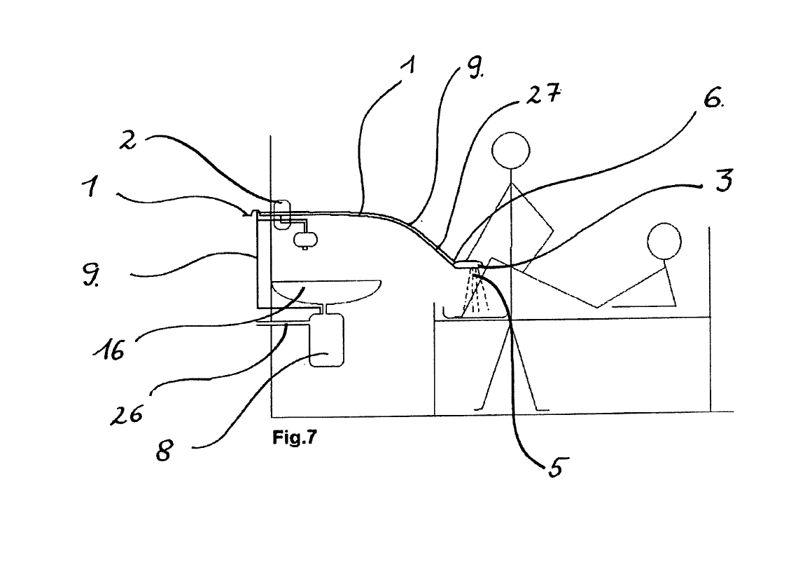

FIG. 7 shows a further embodiment of the device according to the invention. A water line 1 is provided on the water fitting 2 with a flexible supply and removal line 27 and a point-of-use cross-flow liquid sterile filter 3. The flexible supply and removal line contains a water line 1 through which germ-containing water 15 reaches the cross-flow liquid sterile filter 3, and a retentate line 9 which is connected to the retentate outlet 6 of the cross-flow liquid sterile filter 3. During the filtration, the germ-containing retentate 7 passes through the retentate line 9 into a self-disinfecting drain trap 8, which is located under a wash basin or sink 16. The filter housing 22 is provided with a shower grip 21. The sterile permeate 5 emerging from the showerhead-like permeate outlet 4 of the cross-flow liquid sterile filter 3 produces a shower jet with which the relevant area of the body is cleaned.

### LIST OF REFERENCE SIGNS

(1)=water line
(2)=water fitting
(3)=cross-flow liquid sterile filter
(4)=permeate outlet
(5)=permeate
(6)=retentate outlet
(7)=germ-containing retentate
(8)=self-disinfecting drain trap
(9)=retentate line
(10)=permeate outlet protector
(11)=self-closing polymer body
(15)=germ-containing water
(16)=wash basin or sink
(17)=water-fitting housing
(18)=retaining bead
(19)=hollow-fiber membrane filter insert
(20)=seal
(21)=shower grip
(22)=filter housing
(23)=hollow-fiber membrane
(25)=shower tray
(26)=waste-water line
(27)=flexible supply and removal line

1. A device for producing sterile water, having a water line (1) and a point-of-use cross-flow liquid sterile filter (3) with at least one permeate outlet (4) for a permeate (5) and at least one retentate outlet (6) for germ-containing retentate (7), wherein the filter (3) is mounted on a water fitting (2) or integrated in a water-fitting housing (17), characterized in that the device has an apparatus (8) for disinfecting the germ-containing retentate (7), and the retentate outlet (6) of the point-of-use cross-flow liquid sterile filter (3) and the apparatus for disinfecting the germ-containing retentate (7) are connected to each other via a retentate line (9), through which germ-containing retentate (7) arising in the point-of-use cross-flow liquid sterile filter (3) is transferred into the apparatus (8).

2. The device for producing sterile water as claimed in claim 1, characterized in that the apparatus (8) for disinfecting the germ-containing retentate (7) is a self-disinfecting drain trap (8).

3. The device for producing sterile water as claimed in claim 1, characterized in that the cross-flow liquid sterile filter (3) is integrated in a water-fitting housing (17).

4. The device for producing sterile water as claimed in claim 1, characterized in that the cross-flow liquid sterile filter (3) contains hollow-fiber membranes (23).

5. The device for producing sterile water as claimed in claim 1, characterized in that the permeate outlet (4) of the point-of-use cross-flow liquid sterile filter (3) is provided with a permeate outlet protector (10).

6. The device for producing sterile water as claimed in claim 5, characterized in that the permeate outlet protector (10) is composed of a tubular, self-closing, elastic polymer body (11) which is opened by the pressure of the permeate (5) generated in the filter interior and which is closed again by the external air pressure after completion of the discharge of the permeate from the cross-flow liquid sterile filter (3).

7. The device for producing sterile water as claimed in claim 6, characterized in that the polymer body (11) is provided with additives of antimicrobial substances or with an antimicrobial coating.

8. A method for producing sterile water, wherein germ-containing water is cleaned in a device using the following steps:
a) germ-containing water (15) flows from a water line (1) into a point-of-use cross-flow liquid sterile filter (3),
b) the microorganisms present in the germ-containing water (15) are held back in the filter (3) and accumulate in a germ-containing retentate (7),
c) resulting permeate (5) leaves the point-of-use cross-flow liquid sterile filter (3) via the permeate outlet (4),
characterized in that
d) the germ-containing retentate (7) is conveyed continuously out of the filter (3) via a retentate outlet (6) during the filtration process b),
e) the germ-containing retentate (7) is transferred from the retentate outlet (6) through a retentate line (9) into an apparatus (8) for disinfection, and
f) the pathogens contained in the germ-containing retentate (7) are all killed in the apparatus (8) without interruption of the filtration process b).

9. (canceled)

10. The device for producing sterile water as claimed in claim 2, characterized in that the cross-flow liquid sterile filter (3) is integrated in a water-fitting housing (17).

11. The device for producing sterile water as claimed claim 2, characterized in that the cross-flow liquid sterile filter (3) contains hollow-fiber membranes (23).

12. The device for producing sterile water as claimed claim 3, characterized in that the cross-flow liquid sterile filter (3) contains hollow-fiber membranes (23).

13. The device for producing sterile water as claimed in claim 2, characterized in that the permeate outlet (4) of the point-of-use cross-flow liquid sterile filter (3) is provided with a permeate outlet protector (10).

14. The device for producing sterile water as claimed in claim 3, characterized in that the permeate outlet (4) of the point-of-use cross-flow liquid sterile filter (3) is provided with a permeate outlet protector (10).

15. The device for producing sterile water as claimed in claim 4, characterized in that the permeate outlet (4) of the point-of-use cross-flow liquid sterile filter (3) is provided with a permeate outlet protector (10).
